(19) United States
(12) Patent Application Publication
(10) Pub. No.: US 2022/0297386 A1
(43) Pub. Date: Sep. 22, 2022

(54) CONTINUOUS SEALING MACHINE FOR TWO PLASTIC FILMS

(71) Applicants: Maria Immaculada Char Abdala, Barranquilla (CO); David Emanuel Manotas Char, Barranquilla (CO)

(72) Inventors: Maria Immaculada Char Abdala, Barranquilla (CO); David Emanuel Manotas Char, Barranquilla (CO)

(21) Appl. No.: 17/627,073

(22) PCT Filed: May 7, 2020
(86) PCT No.: PCT/IB2020/054303

§ 371 Date: Jan. 13, 2022

(30) Foreign Application Priority Data
May 13, 2019 (CO) NC2019/0004838

(51) Int. Cl. B29C 65/78; B29C 65/20; B31B 70/64

(52) U.S. Cl. CPC B29C 65/7861; B29C 65/20; B31B 70/649; B29L 2031/7128

(57) ABSTRACT

The Continuous Sealing Machine for two plastic films performs continuous sealing of two films, a tubular with gussets and a plastic film, folds the gussets of the new compartment and as a result two compartment rolls are obtained, both compartments with gussets. This high performance machine provides the means for a modernization of the plastics industry. It is a machine on a main structure consisting of: Unwinders Outriggers Edge aligners Pulling roller systems Antistatic bars Antistatic bars Special device Motors with gearbox coupled to gearbox Automatic brakes Electromagnetic clutches continuous sealers Bellows former Camshaft sealers Front puller roll pitch motor Winding rods, foil positioning systems. It is part of the plastic industry machines together with extruders, printers, sealers, trimmers, raw material mixers and stencil assembly machines.

### BACKGROUND OF THE INVENTION

### Field of the Invention

The purpose of this patent application is to file a patent for the invention of a Continuous Sealing Machine for two Plastic Films. The Continuous Sealing Machine of two Plastic Films provides the means for a modernization of the plastics industry.

### Description of Related Art

Machines in the plastics industry have become more efficient, have achieved better performance and precision. These characteristics have achieved important advances. However, these are the machines we know and there is a new trend to take care of the planet.

The plastic industry is going through a period of unpopularity due to environmentalist currents that have denounced the plastic industry's production as a major factor of pollution.

With the Continuous Sealing Machine of two plastic films, we will achieve ecological productions that will allow us all to contribute to the care of the environment.

This way we all take care of the planet, and the plastics industry will experience a resurgence.

If the trend is heeded, it will revitalize the plastics industry and improve its image. PATENT ANTECEDENT 10162208, MULTI-COMPARTMENT PLASTIC GUSSET BAGS

The two plastic film continuous sealing machine differs from the two compartment bag as a patent, both are patents of invention with the difference that one refers to a product and a method for its manufacture and the patent two plastic film continuous sealing machine refers to an invention for the industry, the sections of the industry are not affected with the introduction of the machine, no adaptations are required, it works with the sections in an independent section, the product of the patent two-compartment bags is for the use of people to carry products to their homes, in one compartment food and in the other compartment toiletries, subsequently to be used as a deposit, in one compartment recyclable waste and in the other non-recyclable waste, the two-compartment bag as a product is a patent that exceeds the state of the art where there are plastic bags that do not allow the classification of products or in its second use the separation of waste, the patent machine is in the industrial context has industrial characteristics, we refer to speeds, accuracy, film tension, sealing temperature, position correction, cold behavior, all industrial characteristics and we do not refer to the manufacture of a product but to the manufacture of rolls within an industrial process where there are sections, some upstream and others downstream, we guarantee performance characteristics, high speeds, performance, all industrial characteristics, it is not an improved method it is a new patent with industrial orientation that goes beyond the state of the art to become part of the industry.

The general objective of this invention is to provide means for a modernization of the plastics industry.

### SUMMARY OF THE INVENTION

The two-film continuous plastic film sealing machine is a high-performance machine that performs the production of two-compartment tubulars with bellows.

It performs the continuous sealing of two films, a tubular with bellows and a plastic film, folds the bellows of the new compartment and as a result, two-compartment tubulars are obtained, both compartments with bellows.

It is a machine on a main structure consisting of: unwinders, rocker arms, edge aligners, puller roll systems, anti-static bars, special device, motors with coupled gearbox, automatic brakes, electromagnetic clutches, continuous sealers, bellows former, sealer camshaft, front puller roll pitch motor, winding bars, sheet positioning system.

The Continuous Sealing Machine of two plastic films is part of the plastic industry machines along with extruders, printers, sealers, trimming machines, raw material mixers and cliché assembly machines.

### BRIEF DESCRIPTION OF THE DRAWINGS

FIG. 1 is an isometric view of a continuous sealing machine in accordance with an embodiment of the invention.

FIG. 2 is a left side view of a continuous sealing machine in accordance with an embodiment of the invention.

FIG. 3 is a right side view of a continuous sealing machine in accordance with an embodiment of the invention.

FIG. 4 is a rear view of a continuous sealing machine in accordance with an embodiment of the invention.

FIG. 5 is a top view of a continuous sealing machine in accordance with an embodiment of the invention.

FIG. 6 is a set of examples of industrial processes of a continuous sealing machine in accordance with an embodiment of the invention.

### DETAILED DESCRIPTION OF THE INVENTION AND DRAWINGS

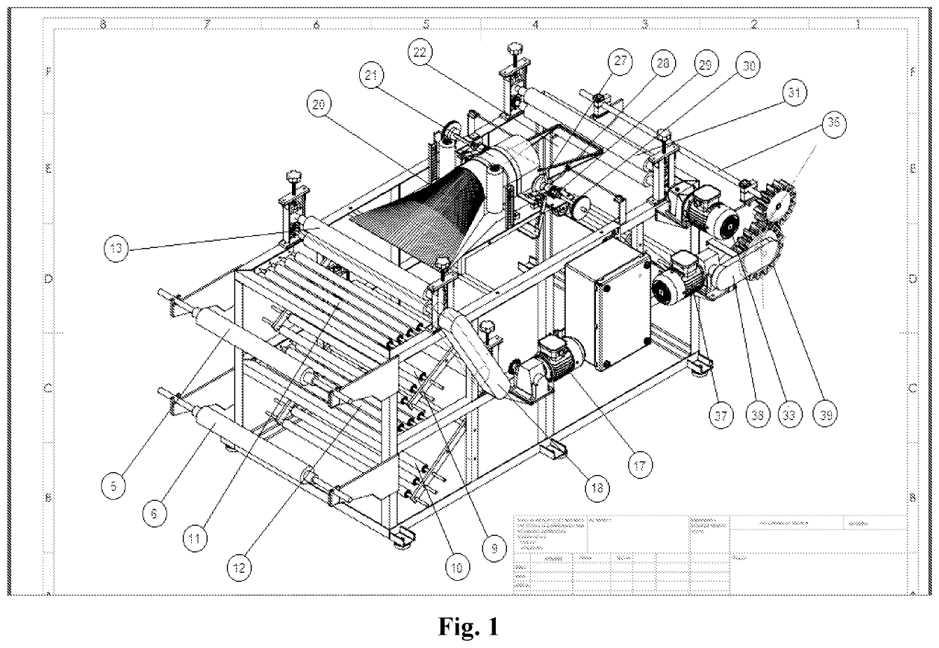

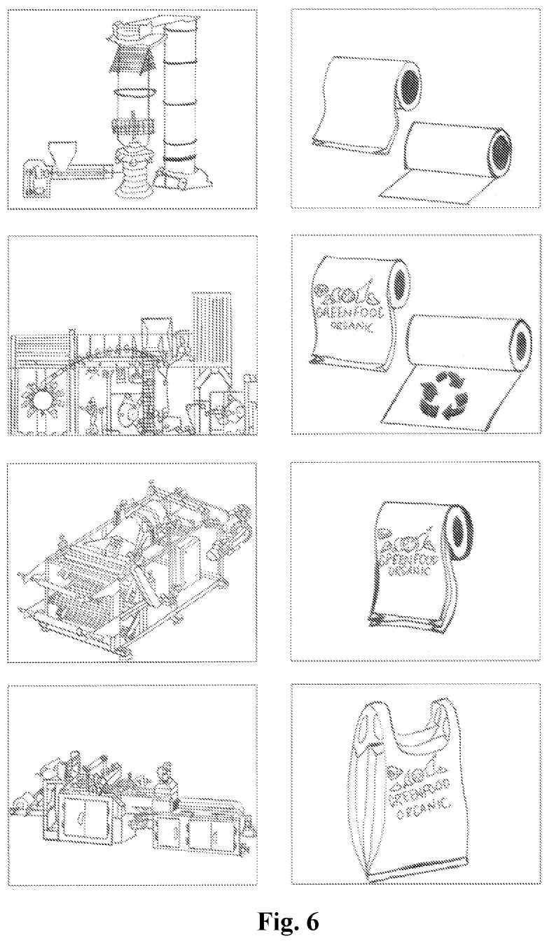

Description will now be given with reference to the attached FIGS. 1-6. It should be understood that these figures are exemplary in nature and in no way serve to limit the scope of the invention, which is defined by the claims appearing hereinbelow.

The Continuous Sealing Machine for two plastic films seals a plastic film and a tubular film with bellows on both sides. On the upper unwinder (1) the film reel is placed on the film reel and on the lower unwinder (2) the tubular film reel with bellows is placed on the lower unwinder (2). The foil film is fed through a puller roller system (7) and the tubular film with bellows through a second puller roller system (8). To avoid negative factors during sealing, the unwinders have been decoupled from the main structure, since the unwinders use an edge aligning system that produces transversal movements on the unwinding bars to correct the alignment of the films, both unwinders have this system that produces vibrations. In the main structure of the machine (33) there is a special device (37) that gives an arc shape to a film by placing its edges on the edges of the tubular with bellows. The device has three segments, the first segment (12) gives the sheet the shape of an arc. The second segment (15) is a stainless-steel arched tunnel with flat flaps and sealing windows with continuous sealers (16) and (17) for sealing the films. Finally, the third element forms the bellows of the new compartment. The films advance, the laminated film above the device and the tubular film with bellows below the device. At the front of the main structure of the machine is located a system of front puller rollers (22), this system of puller rollers keeps the tension of the films constant for a good performance during the sealing and the forming of the bellows of the new compartment. At the end of the structure are located the constant tension winders with clutch (32). Clutch winders tend to overheat, so two winders are used, one working while the other rests to ensure machine availability and performance.

In FIG. 1, The figure shows the continuous sealing machine, it has two unwinding bars at the entrance (1) and (2), the three guide rollers (5) and (6) act with the three rocker rollers (3) and (4), the two vulcanized rubber puller roller systems do the pulling at the entrance (7) and (8). The part in the central part of the machine has three segments, in the central segment (15) there are two sealing wheels (16) and (17), mounted on shafts with supports and transmission pulleys (18) and (19). The third segment shows the external fittings of the bellows former (20) and (21). The front puller rollers (22) are connected to a motor (23). The motor of the winders (24) is connected to a clutch (26) which transmits the movement to the bar.

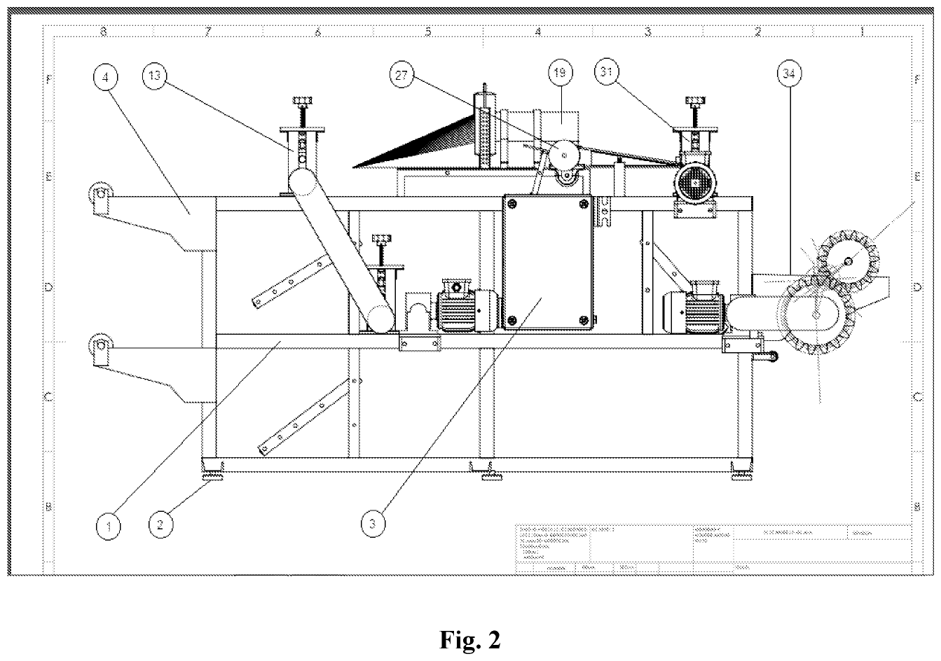

In FIG. 2, on a main structure (33) we can see the unwinders (1) and (2), the rocker arms (3) and (4), the puller rollers (7) and (8), the pinion mechanism (9) and (10) with motor (11), the electrical box (31), the motor of the winders (24). The upper part shows the sheet positioning rollers (13) and (14), the sealing wheel pulleys (18) and (19), the external accessories of the bellows former (20) and (21). The central part for the cold behavior of the sheet (15), the front puller rolls (22), the motor of the front puller rolls (23) and the winder (32).

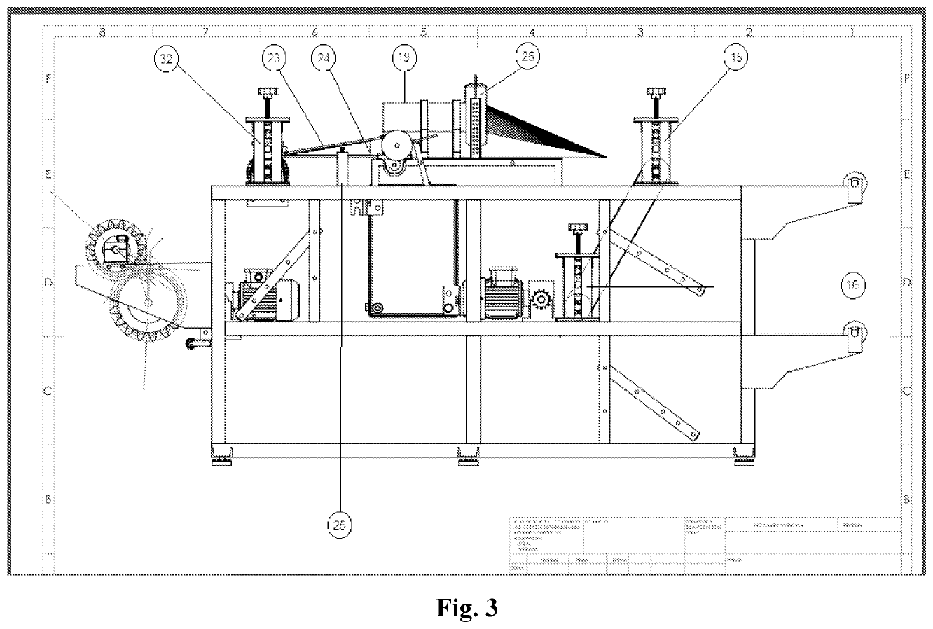

In FIG. 3, we can see the first part of the device (12) this part arranges the film on the arc tunnel, its ascending shape, its symmetries, its low friction coefficient allow the film to move at high speeds and an ideal behavior. In the arched tunnel (15) we observe the film positioning rollers (13) and (14) and the sealing wheels (16) and (17). In the figure the film positioning rollers are in vertical position, although during operation they are positioned horizontally. The sealing wheels are attached to an axle (34) and (35), the wheel supports can be seen. (27) and (28), the collector and brushes (29) and (30) and the pulleys (18) and (19).

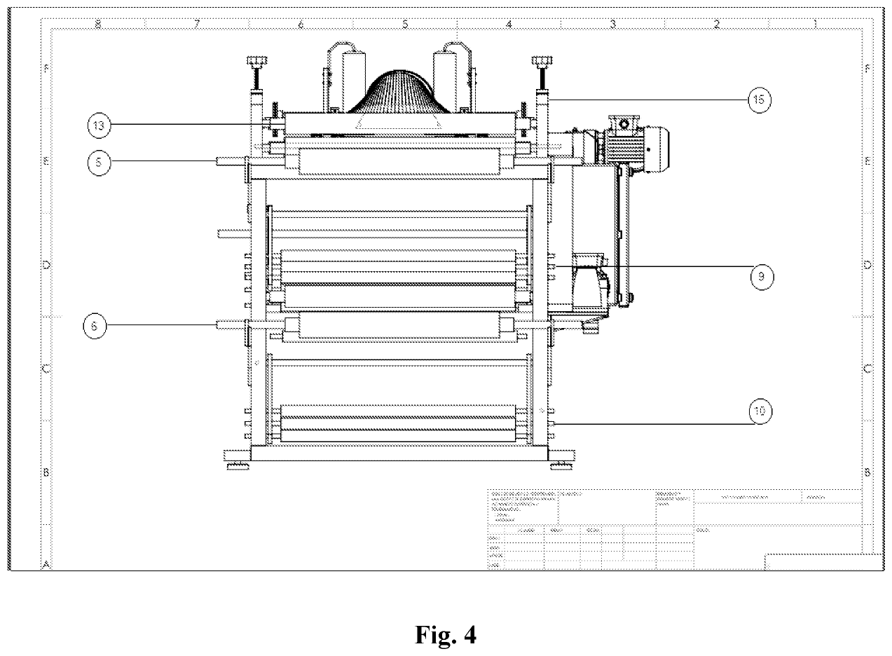

In FIG. 4, the figure shows the stainless steel arched tunnel (15), its height determined by the width of the films, the support of the sealing wheels with bearings (27), the shaft of the sealing wheels (34) and (35) and the pulleys (18) and (19). The assembly of the infeed rollers (7) with pressure adjusting screw (36) can be seen.

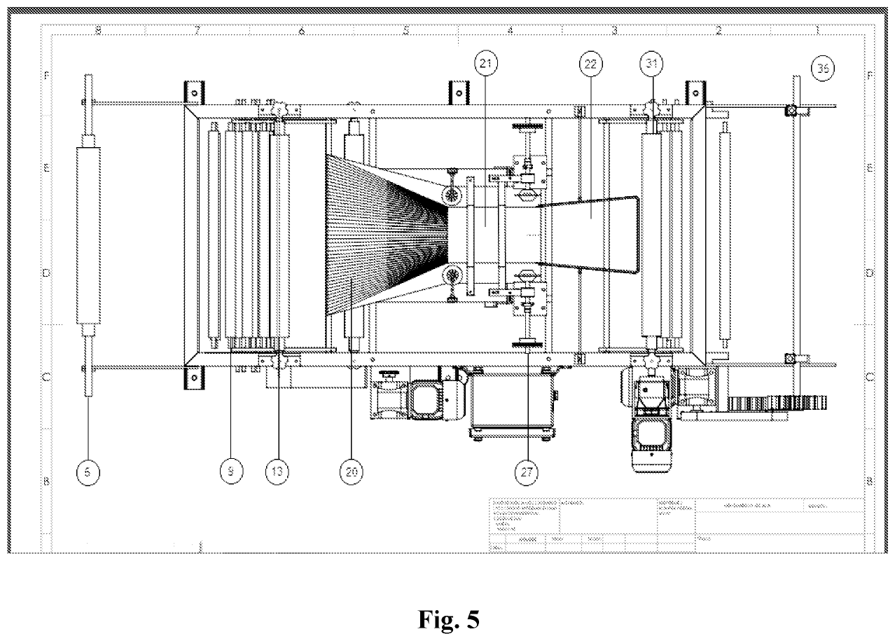

In FIG. 5, the complete film path, the upper unwinder (1), the infeed rollers (7) and (8), the first element of the special device (12), the stainless-steel arched tunnel with flat flaps and sealing windows can be seen ((15) and the front puller rollers (22)).

This general description helps us to locate the parts in the structure of the machine, in the chapter Machine Parts explains in detail its operation.

### Continuous Two Film Sealing Machine in the Plastics Industry

In the plastics industry there are three sections: extrusion, printing and sealing.

The continuous sealing machine for two plastic films performs the joining of a tubular with bellows and a plastic film.

The two rolls are produced in the extrusion section, in the printing section one of the two rolls is printed.

The continuous sealing machine for two plastic films joins the two films—the tubular and the film—and as a result provides us with a double tubular, both compartments with bellows.

### Characteristics:

Industrial performance Accuracy High Speed
Availability: 24 hours as it has two constant tension winding motors with electromagnetic clutches.
Speed: from to 180 meters 220 per minute.
Output: Production capacity is determined by machine speed and packaging specifications. A 120 kg roll, at 180 meters per minute: 13.32 minutes. A 120 kg roll, at 220 meters×minute: 10.9 minutes.
Quality monitoring: film detection during the sealing process, sealer temperature measurement, edge alignment system, film positioning rollers. These machine features ensure film sealing or stop the machine and alert the operator.

### High Performance Features:

Antistatic bars
Edge alignment system on unwinder bars
Sealer camshaft
Pitch motor of the front puller rollers
Automatic brakes
Electromagnetic clutches
Film positioning servomotors
Film detection sensors

### Safety and Operation:

Safety guards, wheel damping, machine anchors, emergency stops, electrical safety, low noise and low vibration systems, finishes, painting, notices, warnings.
Manuals and spare parts box.

### Machine Parts

Machine structure (33)

It consists of two parts. The structure of the unwinders decoupled from the main structure and the main structure with the supports for the parts.

### Unwinding Bars (1) and (2)

The unwinder bars are steel bars, with a toothed wheel at one end for coupling to the magnetic brakes. They have cast iron stops with a safety pin with thread that adjusts to fix the rolls to the bar. The unwinder has at its other end a bushing divided in two with a safety lock to hold the bar.

Constant Tension Unwinders (1) and (2) with Rocker-Controlled Brakes

The unwinders will be decoupled from the main structure so that vibration will not affect the sealers or subsequent stages, sheet positioning rollers, bellows former.

The foil coil is placed on the constant tension unwinder with a rocker arm-controlled brake located at the top. The bellows tubular reel is placed on the constant tension unwinder with brake located at the bottom. The rocker arm (3) and (4) ensure a constant tension on the films in such a way that if the tension decreases, the brake on the spool is activated and if the tension increases, the spool is released from the brake and thus the rocker arm continuously regulates the tension.

### Edge Alignment System on the Unwinder Bars

For continuous operation, an edge aligner is used to move the bar on which the film reel or roll is placed.

The moving bed has a roller at the height of the rollers of the upper plane of the rocker arm, which moves with the bed. Just before this roller are located the edge-aligning sensors, on the structure where the moving bed is located. The sensors do not move with the bed.

The sensor uses a reference to move the bed to the right or left to perform the alignment correction to ensure that the edges of the film and tubular match exactly at the time of sealing. The edge aligning sensors are placed on the same side on both films. The edge alignment correction is done on a bed that supports the unwinding bars through transversal movements towards the required side by means of a double rotation motor and an auger attached to the bed to permanently center both films.

### Inlet Feeder Puller Roller System (7) and (8)

Both films pass independently through feed rollers. These rollers have a vulcanized rubber coating on the outside to continuously pull the films.

Sprocket Mechanism (9) and (10) and Chain with Motor (11)

The films must maintain a constant linear speed which must be equal on both to ensure sealing, to ensure this both feed roller systems will be linked together by means of a sprocket and chain mechanism and traction will be provided by a single motor with independent speed control.

### Antistatic Bars

The electrode bars or antistatic bars are located at the entrance of the films.
The antistatic bars incorporate an inductive coupling that achieves static neutralization.
Operating voltage: V7000.
Stainless steel emitters on insulating material.
Antistatic bars eliminate static electricity from materials by producing positive and negative ions that neutralize those of the material to be de-ionized.
Static-free material is deployed on the surface of the special device.
Special device (37)

It is a device specially designed to condition the films so that their edges match at the time of sealing and for the behavior of the cold film for bellows folding. Its location is from the top entry puller rolls to the front puller rolls.

It is made up of:

First segment of the special device is the element that shapes a sheet or input element of the device (12).

Second segment of the special device is a stainless steel arched tunnel with flat ailerons and sealing windows or central element of the device (15).

The third segment of the special device is the element where the bellows of the new compartment or bellows former are formed.

### Device Input Element (12)

The first element of the device receives the sheet from the feeding rollers of the machine and places it on the tunnel. It receives the flat sheet, at the same level as the tubular, and brings it up to the height of the tunnel. The purpose of this segment of the device is to take the flat sheet as wide as it is and guide it while making it take the shape of an arc so that in this transition the edges of the sheet are brought closer to the edges of the tubular. When reaching the height of the tunnel at the lower ends of the tunnel, the edges of the sheet coincide with those of the tubular.

Stainless Steel Arched Tunnel with Flat Ailerons and Sealing Windows (15)

The second element of the device has the shape of a tunnel on which the sheet is placed. Below this tunnel is the tubular with bellows, both moving at the same speed. The purpose of this segment of the device is to seal the two films on both sides in the sealing windows.

### Bellows Former

Now the sheet must descend to the same level as the tubular and coincide with the same width, because now it will have bellows. This part of the device consists of an inner and an outer part. The inner part of the bellows former guarantees the exact shape of the new compartment located over the original tubular and ensures that when the bellows of the new compartment are formed, the pressure on the films does not deform the original tubular. It does this in the following way: inside the new compartment it creates through two metal frames the shape of the expanded compartment necessary for the bellows to be inserted into the new compartment. The outer part of the bellows former uses the outer fittings of the bellows former (20) and (21) by means of which it inserts the bellows into the new compartment.

### Rectangular Metal Frame

At the bottom, the bellows former has a rectangular metal frame in contact with the top face of the original tubular, which holds it in place during the process of forming the new bellows where pressure is exerted on it.

### Trapezoidal Metal Frame

From the top of the tunnel to the tunnel exit, the bellows former has a downward trapezoidal metal frame so that the film makes the natural transition from the top of the tunnel to the bottom of the device where the original tubular is located.

### Bellows Former External Fittings (20) and (21)

On the outside of the film, between the two metal frames, on each side the bellows are inserted through the external fittings of the bellows former which consist of two pieces of wood that push in the material, similar to those used conventionally. These wooden pieces do not produce splinters and have a polished finish.

### Blade Positioning Rollers (13) and (14)

The sheet positioning rollers located at the lower ends of the arched tunnel rotate outward with independent motors and ensure the sheet position.

### Two-Speed Motor of the Foil Positioning Rollers

To ensure that the new two-compartment film is completely sealed the film positioning rollers (13) and (14) use capacitive film detection sensors and a two-speed motor that performs film correction and positioning displacements.

The capacitive sensors are aligned in threes.
Film detection is performed with capacitive sensors.

Capacitive sensors measure capacitance because the film is an insulating material, the capacitance increases with the film, so capacitive sensors detect the film.

0.4=diameter of each sensor 0.8=width of wheel sealing

The outermost or third sensor detects the film on one side and performs the speed change on the roller on the opposite side. The film positioning roller motors have two speeds, one speed causes the film to extend over the device the other speed causes the film to move to make the positioning correction.

The second speed provides continuous film pulling.
Thus, the Friction Velocity Area ratio equals the correction displacement.
The film is constantly displaced on both sides and sealing is guaranteed.

### Continuous Sealing System

The continuous sealing system performs the sealing of the films. It performs the function of sealing the edges of the film and the tubular with bellows on both sides. Its main component are the sealing wheels (16) and (17) located in the sealing windows. The continuous sealing system consists of:

Bronze Sealing Wheels (16) and (17) with Heating Elements

### Thermocouple and Electric Thermostat

Collector and brush system (29) and (30)
Shaft (34) and (35) and support (27) and (28) of the sealing wheels Non-stick Teflon tape
Sealing wheel damping system
Sealing wheel pulleys (18) AND (19)
Sealing wheel camshaft
Sealant bases and tubular guides
Bronze Sealing Wheels (16) and (17) with Resistors

The sealer is a bronze wheel with high relief cross-hatching that provides a safety seal. It rotates on a shaft (34) and (35), the resistors are cylindrical and are located in the center or core of the wheel where the holes for the resistors have been drilled.

### Thermocouple and Electric Thermostat

The temperature is adjustable and is controlled through the reading of a thermocouple housed in the center of the wheel by means of an electric thermostat. There are two thermocouples, one in each wheel and two thermostats to control the temperature of each wheel. If the temperature rises in the wheels the thermostat de-energizes the resistors and if it falls it energizes turning on the resistors, with some temperature curves it manages to maintain the constant sealing temperature.

### Collector and Brush System (29) and (30)

Power is provided by a collector and brush system. The commutator rotates with the wheels and has conductive tracks that transmit electricity. The carbon brushes remain static and transmit the electricity to the collector tracks.

### Shaft (34) and (35) and Support (27) and (28) of the Sealing Wheels

A shaft (34) and (35) is used as a support for the sealing wheels, which holds the sealing wheel (16) and (17) and rotates with the sealing wheel. It has three main parts. The first one is to hold the sealing wheel, the second part carries inside it the wires of the resistors that are connected to the collector that rotates together with the shaft. The third part is to support the sealing wheel pulley (18) and (19) from where the wheels receive the traction. The shaft is attached to a support (20) and (21) with bearing which functions as a support for the parts. The support is an arm that has a pivot point, its second function is to raise the wheels by action of the camshaft.

### Teflon Non-Stick Tape

The sealing wheels use non-stick Teflon tape to achieve the controlled parameters of temperature, pressure, sealing time, during the operation of the sealers. The Teflon tape is non-stick and thus does not allow the films to stick to the sealers, thus achieving stable parameters and continuous work.

### Sealing Wheel Damping System

The sealing wheels use compression springs to ensure contact with the films at high speeds. The springs are located in the arm or support of the sealing wheels and act in both positions of the wheel, in contact with the films and in an elevated position.

### Sealing Wheel Pulleys (18) and (19)

The speed of the sealing wheels must be identical to that of the film or the film will tear on contact with the wheels at high temperatures. This is achieved by using pulleys that receive traction from the feed rollers. The pulleys should be of the same dimension on the wheels and on the feeder rolls, two pulleys one on each wheel and two pulleys on one of the feeder rolls, one on each side, connected with elastic belts of circular cross section.

### Sealing Wheel Camshaft

It has two positions.
The raised position raises the sealing wheel.
When the cam is in the second position the wheel contacts the films.

### Sealant Bases and Tubular Guides

As bases for the sealing of the films, flat rectangular pieces are used, one on each side of the films, which are placed between the folds of the bellows of the original tubular. In addition to providing support for the sealants, this prevents the upper fold from sealing with the lower fold of the bellows of the tubular, which would spoil this compartment. It also serves as a guide to ensure the correct position of the original tubular. These pieces are made of aluminum of a suitable thickness and with rounded edges to avoid heating and to improve the displacement conditions of the tubular film.

### Front Puller Roller System (22)

At the exit of the special device the front puller roller system advances at the same speed as the infeed rollers and maintains the tension of the two-compartment film in both compartments with bellows.

### Front Puller Roller System Stepper Motor (23)

The front puller roller system advances at the same speed as the infeed rollers and maintains film tension.

If this does not happen, the films suffer a shift to the right or to the left, making the seal on one side defective.

The stepper motor allows the front puller roller system to advance in degrees while maintaining the speed of the films and performs the tension correction.

If the voltage decreases, the current also decreases in the motor power supply.

To perform the voltage correction, the stepper motor is advanced a few degrees. Increasing the voltage increases the current intensity, making the respective correction.

Two Constant Tension Winders with Clutch (32)
When one motor is working, the other rests.
For working 24 hours
365 days per year

The electromagnetic clutch couples the motor to the load.

While the field assembly is fixed and prevented from turning, the rotor assembly is secured.

When the coil is energized the armature positively connects the motor to the load.

Thus, boosting the load at high medium and low speed.

### The Two-Track Continuous Film Sealing Machine for Two Plastic Films

Today's plastics industry manufactures two-track rolls, so in extrusion, printing and sealing areas, more efficient production is achieved. Productivity is very important, so machines have improved their efficiency with two-track production.

The Continuous Two-Track Film Sealing Machine described below is no exception. With two-track productions it achieves unsurpassed for their performance in terms of accuracy, speeds, availability and throughput.

The two-track Continuous Film Sealing Machine uses two modules, one for blowing the balloons to form the new bellows and one for rewinding to split the film.

The first module divides the tubular with a hot knife and seals it longitudinally, uses an arched support that contributes to the rapid cooling of the films, fills the two tubulars with air with air guns and forms the bellows of the two tubulars.

In the bellows forming tower, the upper puller rollers ensure that air does not escape from the balloons. The upper puller rollers are equipped with shutters that do not allow the balloons to move forward or backward.

Wooden parts insert the bellows. The louvers ensure symmetries.

The second trimming module splits the sheet in two with a cold knife. The positions of the two modules are described below.

The balloon blowing module is located at the rear and the tubular films use guide rollers for their location on the rocker arms.

The foil trimming module is located in front of the blowing module above, it uses guide rollers for its location on the upper rockers.

The two foil films move outward. Likewise, the two tubular films with bellows are centered on each other.

For this purpose, two rotating guide rollers are used, mounted in such a way that they receive the films and project them outwards to obtain the displacement.

Then, the foil and tubular films with bellows enter the rocker arms independently. The work of the rocker arms is very important as the input tension must be equal on both tracks.

Then the independent rocker arms, two for each track, achieve the tensions.

The infeed rollers with their system of sprockets and motorized chain feed the films on both sides.

Then two special function devices, one for each track, position the edges of the foil films on the edges of the tubular films with bellows.

Both special function devices with their sealing wheels, sealer bases and foil positioning rollers.

The front puller rollers with their stepper motor maintain the tension.

Split winders, each side with its electromagnetic clutches and motor make up the two-compartment rolls.

### Double-Sided Printing

Tubular films with bellows and foil are now printed. Both prints have the print bar used by optical readers in sealing. Our machine has to center both prints. For this ituses the stroboscopic effect that facilitates the operation and a moving roller that moves in the direction of the films on a metal frame, there are four rollers, the two back ones do not move, the front one on top moves centering the prints.

A servomotor is also used to adjust the position of the moving roller. In this case, optical readers are used to locate the tags.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. CLAIM, CONTINUOUS SEALING MACHINE FOR TWO PLASTIC FILMS
As for complex systems, when we understand that the machine is made up of complex systems that have functions and constituent parts, we obtain the machine construct.
Continuous Sealing Machine for two Plastic Films CHARACTERIZED BECAUSE it performs continuous sealing of two films, a tubular with gussets and a plastic sheet and as a result manufactures two-compartment rolls both compartments with gussets. This high-performance machine provides the means for a modernization of the plastics industry.
Constituent parts:
Main structure Ignition panel
Constant tension unwinders with rocker-controlled brakes
the system of feed rollers
The special device
The continuous sealing system the front puller roller system
The two constant tension winders with clutch

2. Claim machine structure of the claim 1
The structure of the machine is made up of two parts, the main structure which is metallic (33) and the structure of the unwinders. It is a metallic structure, with anchorages, formed by:
The film inlet puller rollers (7) and (8)
The front puller rollers (22)
The guide rollers (5) and (6)
Rocker arms (3) and (4)
Brackets for machine parts
Brackets for motors
The structure of the unwinders is a metallic structure with anchorages formed by two mobile benches, unwinding bars (1) and (2), guide rollers, supports for the parts. The unwinder structure is decoupled from the main structure due to the vibration produced by the moving beds.

3. Claim, Ignition board of the machine of claim 1.
Machine ignition board characterized in that it comprises the following parts:
Ignition key for the machine.
Manual ignitions for the motors.
Knobs and indicators for motor speed.
Sealing wheels temperature ignition.
Temperature knobs and indicators for sealing wheels.

4. CLAIM, CONSTANT TENSION UNWINDERS WITH BRAKE CONTROLLED BY CLAIM ROCKER ARM OF THE claim 1
It is a complex system with functionality to provide both types of film.
Constant tension unwinders with brake controlled by rocker arm, characterized in that they consist of unwinding bars (1) and (2), rocker arms (3) and (4) and brakes. The film reels—foil and tubular with bellows are placed on the unwinding bars, (1) and (2). The film reel is placed on the constant tension unwinder with brake located at the top and the tubular reel with bellows is placed on the constant tension unwinder with brake located at the bottom. The rocker arm ensures a constant tension on the films in such a way that if the tension decreases, the brake on the reel is activated and if the tension increases, the reel is released from the brake regulating the tension of the films at the entrance.
Constituent Parts:
Unwinding bars (1) and (2)
Split bushings with safety latches Stops with locking pin.
Magnetic brakes.
Rocker arms (3)
and (4).
Edge alignment system on the unwinder bars

5. Claim, edge alignment system on the unwinder bars of the claim 4
Edge alignment system on the unwinding bars characterized because it is made up of mobile benches, edge alignment sensors and a double turn motor. The edge alignment correction is done on a bed that supports the unwinding bars through transversal movements towards the required side by means of a double turn motor and an auger attached to the bed to align the edges of both bars.
The mobile bed has a roller at the height of the rollers in the upper plane of the rocker arm, which moves with the bed. The moving bed has a roller at the height of the rollers in the upper plane of the rocker arm, which moves with the bed. Ahead of this roller is the edge aligning sensor. The sensors do not move with the bed. The sensor moves the bed to the right or left to make the correction.

6. Claim, feeder puller roller system of claim 1.
It is a complex system of relative matching functionality that maintains a constant between parameters and availability of the films for sealing.
CHARACTERIZED IN THAT both films pass independently through feeder rollers (7) y (8). These rollers have a vulcanized rubber layer on the outside to continuously drag the films.
There are two puller roller systems, one for sheet film and the other for tubular film with bellows.
They are located on the main structure (33), the film inlet rollers are called upper puller rollers. The tubular film inlet rollers with bellows are called lower puller rollers, due to their position on the main structure.
Constituent parts:
Vulcanized rubber rollers (7) and (8)
Mounting with bearings and pressure adjusting screw Sprocket and chain mechanism (9) and (10)
Motor with gear box coupled (11) Antistatic bars

7. Claim, sprocket and chain mechanism with motor of the claim 6
Sprocket and chain mechanism with motor CHARACTERIZED BECAUSE the films must maintain a constant linear speed which must be equal on both to ensure sealing, to ensure this both feed roller systems (7) and (8) will be linked together by means of a sprocket and chain mechanism (9) and (10) and traction will be received from a single motor with independent speed control (11).

8. Claim, anti-static bars of claim 6.
Antistatic bars characterized because they are located at the entrance of the films. The antistatic bars incorporate an inductive coupling that achieves static neutralization.
Operating voltage: V7000
Stainless steel emitters on insulating material
Antistatic bars eliminate static electricity from materials by producing positive and negative ions that neutralize those of the material to be de-ionized.

9. Claim, special device of the claim 1
It is a complex system determined by components that produce an expected effect in the sheet where three stages mold its shape in a first stage the sheet takes a certain shape in a second stage maintains its shape and in a third stage folds are formed and returns to its flat shape.
Special device characterized in that it is a device specially designed for conditioning the films (37) so that their edges
The rollers are located from the top puller rollers to the front puller rollers and are designed to match at the time of sealing and for the cold sheet behavior for bellows folding. Their location is from the top puller rolls to the front puller rolls. The films are a sheet of width equal to the width of the tubular with bellows plus four times the width of the bellows and a tubular with bellows; we will call the tubular with bellows the original tubular.
Wherein the first segment (12) is an element that forms a sheet or inlet element of the device, the second segment (15) is a stainless-steel arched tunnel with flat flaps and sealing windows or central element of the device and the third segment is the element where the bellows of the new compartment or bellows former are formed.
Constituent parts:
Device input element (12)
Stainless steel arched tunnel with flat flaps and sealing windows (15)
Bellows former
Rectangular metal frame
Trapezoidal metal frame
Bellows former external accessories (20) and (21)
Foil positioning rollers
Two-speed motor of the foil positioning rollers

10. Claim, inlet element of the device of the claim 9
CHARACTERIZED IN that it receives the sheet from the feeding rolls of the machine at the same level as the tubular and brings it up to the height of the tunnel. The purpose of this segment of the device
(12) is to take the flat sheet as wide as it is and guide it while making it take the shape of an arc so that in this transition the edges of the sheet come closer to the edges of the tubular. When reaching the height of the tunnel at the lower ends of the tunnel, the edges of the sheet coincide with those of the tubular.

11. Claim, stainless steel arched tunnel with flat ailerons and sealing windows of claim 9.
Stainless steel arched tunnel with flat ailerons and sealing windows CHARACTERIZED BECAUSE it has the shape of a tunnel on which the sheet is placed. Below said tunnel is the tubular with bellows, both advancing at the same speed. The purpose of this segment of the device (15) is to arrange the films for sealing in the sealing windows.

12. Claim, bellows former of the claim 9
Bellows former characterized in that it consists of an inner part and an outer part. The inner part of the bellows former consists of two metal frames, one rectangular and one trapezoidal. The inner part of the bellows former guarantees the exact shape of the new compartment and ensures that when forming the bellows of the new compartment the pressure on the films does not deform the original tubular. It does this in the following way: inside the new compartment it creates through the two metal frames the necessary expanded compartment shape for the bellows to be inserted into the new compartment. The outer part of the bellows former consisting of the outer bellows former attachments (20) and (21) inserts the bellows into the new compartment.

13. Claim, rectangular metal frame of claim 9.
Rectangular metal frame characterized in that it is located at the bottom of the bellows former, in contact with the top face of the original tubular, which keeps the original tubular in place during the process of forming the new bellows in which pressure is exerted on it.

14. Claim, trapezoidal metal frame of claim 9.
Trapezoidal metal frame characterized in that it descends from the top of the tunnel to the tunnel exit, so that the film makes the natural transition from the top of the tunnel to the bottom of the device where the original tubular is located.

15. Claim, external fittings of the bellows former of claim 9.
External accessories of the bellows former characterized in that they are located on the outside of the film, between the two metal frames, on each side, and introduce the bellows. They consist of two pieces of wood (20) and (21) that push in the material. These wooden pieces do not produce splinters and have a polished finish.

16. Claim, sheet positioning rollers of claim 9.
Film positioning rollers characterized in that they are located at the lower ends of the arc tunnel, rotate outwards with independent motors, spread the film over the arc bringing its edges on both sides to their sealing position, ensure the correct positioning of the film for sealing the films.

17. Claim, two-speed motor of the sheet positioning rollers of claim 9.
Two-speed motor of the foil positioning rollers
Characterized, to ensure that the new two-compartment film is completely sealed the film positioning rollers (13) and (14) use capacitive film detection sensors and a two-speed motor to perform film correction and positioning displacements.
The capacitive sensors are aligned in threes.
Film detection is performed with capacitive sensors.
Capacitive sensors measure capacitance because the film is an insulating material, the capacitance increases with the film, so capacitive sensors detect the film. 0.4=diameter of each sensor 0.8=width of wheel sealing
There are three sensors on each side, two sensors coincide with the sealing width.
The outermost or third sensor detects the film on one side and activates the delta speed on the roller on the opposite side. The film positioning roller motors have two speeds, one speed causes the film to extend over the device the other speed causes the film to move to make the positioning correction.
The second speed provides continuous film pulling.
Thus, the ratio Area Second Velocity Friction equals the correction displacement. The film is constantly displaced on both sides and sealing is guaranteed.

18. Claim, continuous sealing system of claim 1.
It is a complex system of relative correspondence between the result and the continuous sealing of two films.
Continuous Sealing System: characterized because it has the function of sealing the edges of the sheet and the tubular with bellows on both sides.
Constituent parts:
Bronze sealing wheels with resistors (16) and (17) Thermocouple and electric thermostat
Collector and brush system (29) and (30)
Sealing wheel shaft (34) and (35)
Sealing wheel support (27) and (28)
Non-stick Teflon tape
Sealing wheels damping system
Sealing wheel pulleys (18) and (19)
Sealing wheel camshaft Sealing bases and tubular guides

19. A continuous sealing system according to claim 1, wherein
Bronze sealing wheels with resistors: characterized in that they are two bronze wheels with high relief cross-hatching (16) and (17) that provide a safety seal. They rotate at the same speed as the films. The resistors that produce the heat are cylindrical and are located in the center or core of the wheel where the perforations for the resistors have been made.

20. Claim, thermocouple and electric thermostat of claim 18.
Thermocouple and electric thermostat: characterized in that they adjust the temperature of the sealing wheels through the reading of a thermocouple housed in the center of the wheel by means of an electric thermostat. The temperature is adjustable and controlled through the reading of a thermocouple. There are two thermocouples, one in each wheel and two thermostats to control the temperature of each wheel. If the temperature rises the thermostat de-energizes the resistors and if the temperature falls it energizes the resistors, thus keeping the sealing temperature constant.

21. Claim, collector and brush system of claim 18.
Collector and brush system: characterized in that it provides power to the resistors (29) and (30). The resistor leads pass through a conduit that rotates in conjunction with the sealing wheels and connect to the collectors. The collector tracks rotate and the brushes remain static. The collector tracks are made of a conductive material, and are in contact with the graphite or conductive carbon brushes. These conduct the energy to power the electrical resistors.

22. A continuous sealing system according to claim 1, wherein
Shaft and support for the sealing wheels: characterized in that a shaft (34) and (35) that supports the sealing wheel (16) and (17) and rotates with the sealing wheel is used as a support for the sealing wheels. It has three main parts. The first one is to hold the sealing wheel, the second part carries inside it the wires of the resistors that are connected to the collector that rotates together with the shaft. The third part is to support the sealing wheel pulley (18) and (19) from where the wheels receive the traction. The shaft is attached to a support (20) and (21) with bearing which functions as a support for the parts. The support is an arm that has a pivot point, its second function is to raise the wheels by action of the camshaft.

23. Claim, nonstick Teflon tape of the claim 18
Non-stick Teflon tape: characterized in that it allows controlled parameters of temperature, pressure, sealing time, during the operation of the sealers. The Teflon tape is non-stick and thus does not allow the films to stick to the sealers, thus allowing stable parameters during the sealing of the films.

24. Claim, damping system for the sealing wheels of the claim 18
Sealing wheel damping system: characterized in that the sealing wheels use compression springs to ensure contact with the films at high speeds. The springs are located in the arm or support of the sealing wheels and act in both wheel positions.

25. Claim, pulleys of the sealing wheels of claim 12.
Sealing wheel pulleys: characterized in that they receive the traction from the feed rollers. The pulleys (18) and (19) must be of the same dimension on the wheels and on the feed rollers, two pulleys one on each wheel and two pulleys on one of the feed rollers one on each side, connected with elastic belts of circular cross section. The speed of the sealing wheels must be identical to that of the films or they will tear in contact with the wheels at high temperatures, in contact with the films and in the raised position.

26. Claim, camshaft of the sealing wheels of claim 18.
Sealing wheel camshaft: characterized in that it has two positions: The raised position raises the sealing wheel.
When the cam is in the second position the wheel contacts the films.

27. Claim, sealant bases and guides of the tubular of claim 18.
Sealer bases and tubular guides: characterized because they are two flat rectangular pieces of aluminum, one on each side, which are placed between the folds of the bellows of the original tubular. This, in addition to providing support for the sealants, prevents the upper fold from sealing with the lower fold of the tubular, which would spoil this compartment. In addition, they serve as a guide to ensure the correct position of the original tubular. Being made of aluminum, they do not overheat.

28. Claim, front puller roller system of the claim 1
It is a complex system related to a specific function that, in contrast to supplying the sealed film to the unwinders, pulls the films to keep them under tension in order to fulfill their functions related to sealing and forming the bellows of the new compartment.
Front puller roller system: characterized in that it advances at the same speed as the infeed rollers and maintains constant tension of the foil and tubular bellows films during sealing and forming of the new compartment bellows.
Constituent parts:
Vulcanized rubber rollers (22)
Mounting on bearings with pressure adjusting screw (36)
Pitch motor of the front puller roller system (23)

29. Claim, stepper motor of the front puller roller system of the claim 28
Pitch motor of the front puller roller system: characterized in that it maintains the speed of the front puller rollers (22) equal to that of the inlet puller rollers (7) and (8) and keeps the film tension constant.
The stepper motor (23) allows the front idler system (22) to advance in degrees while maintaining the speed of the films and performs the tension correction.
If the voltage decreases, the current also decreases in the motor power supply.
To perform the voltage correction, the stepper motor is advanced a few degrees.
Increasing the voltage increases the current intensity, making the respective correction.

30. Claim, two constant tension winders with clutch of the claim 1
It is a complex system of functionality to provide two-compartment rolls with constant tension bellows to downstream stages.
Two constant tension winders with clutch: characterized in that they wind film from two compartments, both compartments with bellows alternately.
Clutch motors overheat. The function of the two clutch winding motors is to allow the other motor to rest while one motor is working. For work 24 hours a day, 24 days 365a year. The electromagnetic clutch couples the motor to the load.
While the field assembly is fixed and prevented from turning, the rotor assembly is secured.
When the coil is energized the armature positively connects the motor to the load. Thus boosting the load at high, medium and low speed.
The drag on the clutches decreases, thus decreasing the speed of the winders as the reel volume increases. This is done by means of load sensors to maintain a constant tension on the two-compartment film rolls.
Constituent parts:
Winding bars
Split bushings with safety latches
Stops with fixing pin
Motors with coupled gearbox Electromagnetic clutches Load sensors

31. Claim, continuous sealing machine for two plastic films with two tracks
It is a complex system of functionality that relates to the machine while maintaining high performance and achieving high performance and efficiency.
The two-track continuous sealing machine of two plastic films: characterized in that it uses rolls of double the width of tubular and sheet and divides them for the manufacture of two-compartment rolls and two-compartment rolls with bellows in two tracks. This high efficiency and high-performance machine provides the means for a modernization of the plastic industry.
Constituent parts:
Balloon blowing module for bellows forming Foil trimming module Rotating rollers Split rocker arms
Two special function devices Split coilers

32. Claim, balloon blowing module for forming the bellows of the claim 31
Balloon blowing module for forming the bellows: characterized in that it divides the tubular with a hot knife and seals it longitudinally, uses an arched support that contributes to the rapid cooling of the films, fills the two tubulars with air with air guns and forms the bellows of the two tubulars.
In the bellows forming tower, the upper puller rollers ensure that air does not escape from the balloons. The upper puller rollers are equipped with shutters that do not allow the balloons to move forward or backward.
Wooden parts insert the bellows. The louvers ensure symmetries.

33. Claim, film trimming module of claim 31.
Film trimming module: characterized in that it divides the film in two with a cold knife. It uses a slotted metal roller as a blade support.

34. Claim rotating rollers of the claim 31
Rotating rollers: characterized in that they perform the function of moving the films outward to place them in the two devices.
The two foil films move outward. Likewise, the two tubular films with bellows are centered on each other.
For this purpose, two rotating guide rollers are used, mounted in such a way that they receive the films and project them outwards to obtain the displacement.
The rollers are mounted on a metal frame with a pivot and fixing point.

35. Claim, split rocker arms of claim 31.
Split outriggers: characterized in that the laminated films and the tubular films with bellows enter independently into split outriggers. Two upper rocker arms for foil films and two lower rocker arms for bellows tubular films. The work of the rocker arms is very important because the input tension must be equal in both tracks.

36. Claim, two special function devices of the claim 31
Two special function devices: characterized in that one is used for each track. Both with their sealing wheels, sealer bases and film positioning rollers.

37. Claim, the split winders of claim 31.
Split winders: characterized by the fact that each side has two motors with clutches.
When one of the motors is working, the other one rests. There are two motors for each track.

38. Claim, printed on both sides of claim 31.
It is a complex system of functionality to provide the sealing conditions for films with prints centered on both sides.
Double-sided printing: characterized by the fact that the tubular films with bellows and foil are now printed. Our machine has to center both prints. For which it uses the stroboscopic effect that facilitates the operation and a mobile roller that moves in the direction of the films on a metal frame, there are four rollers, the two rear ones do not move, the front one on top moves centering the prints.
Its location on the machine is, for the two-track machine, after the tubulars blowing and foil trimming modules. For the single-track machine, after the unwinders.
Constituent parts:
Stroboscopic effect lamp Metal frame
Four rollers
Single-roller sliding slide Servomotor Optical readers

39. Claim, servomotor operation for centering prints on both sides of the claim 38
Servomotor operation to center the prints on both sides: characterized in that both prints have the print bar used by optical readers in stamping. A servomotor is used to adjust the position of the moving roller. In this case, optical readers are used to locate the tags.
